(19) United States
(12) Patent Application Publication
(10) Pub. No.: US 2013/0151035 A1
(43) Pub. Date: Jun. 13, 2013

(54) VEHICLE SETTING SHARING SYSTEM

(71) Applicants: Kang Won Park, Hwaseong (KR); Nak Hyun Kim, Hwaseong (KR); Sun Min Kim, Hwaseong (KR); Chang Min Yang, Hwaseong (KR); So Jin Lee, Hwaseong (KR); Min Su Kim, Hwaseong (KR); Jeong Gi Yun, Hwaseong (KR)

(72) Inventors: Kang Won Park, Hwaseong (KR); Nak Hyun Kim, Hwaseong (KR); Sun Min Kim, Hwaseong (KR); Chang Min Yang, Hwaseong (KR); So Jin Lee, Hwaseong (KR); Min Su Kim, Hwaseong (KR); Jeong Gi Yun, Hwaseong (KR)

(73) Assignee: HYUNDAI MOTOR COMPANY, Seoul (KR)

(21) Appl. No.: 13/494,555

(22) Filed: Jun. 12, 2012

(30) Foreign Application Priority Data
Dec. 9, 2011 (KR) 10-2011-0131825

(51) Int. Cl. G06F 17/00

(52) U.S. Cl. 701/2; 701/1

(57) ABSTRACT

Disclosed is a vehicle setting sharing system and, more particularly, to a vehicle setting sharing system, which applies vehicle settings, which have been provided for a driver's vehicle, to another person's vehicle as well as to the driver's vehicle to improve the convenience of the driver. The vehicle setting sharing system includes a storage medium configured to store vehicle settings of respective drivers, and a function setting unit configured/structured to receive the vehicle settings of respective drivers from the storage medium and reset functions of a function-executing vehicle based on the stored vehicle settings.

### CROSS-REFERENCE TO RELATED APPLICATIONS

The present application claims priority to Korean Patent Application No. 10-2011-0131825 filed on Dec. 9, 2011, the entire contents of which is incorporated herein for purposes by this reference.

### BACKGROUND OF THE INVENTION

1. Field of the Invention

The present invention relates, in general, to a vehicle setting sharing system and, more particularly, to a vehicle setting sharing system, which applies vehicle settings, which have been provided for a driver's vehicle, to another person's vehicle as well as to the driver's vehicle, thus improving the convenience of the driver.

2. Description of the Related Art

Generally, systems which allow a driver to set devices related to driving convenience or conditions which influence performance are used in vehicles to allow a driver to personalize his or her driving experience. For example, various systems, such as systems for the forward/backward sliding of a seat, the forward/backward tilting movement of the backrest of a seat, the adjustment of the heights of a seat, the tilting of a steering wheel, the angle of left/right side-view mirrors, the angle of a rearview mirror, the manipulation of a head lamp, and the setting of door locking, are provided in vehicles conventionally.

A driver typically must initially manipulate the above systems to suit his or her situation when he or she enters the vehicle for the first time. However, recently the number of drivers for any one vehicle has increased. Furthermore, the number of vehicles that any one user has access to has also increased. Thus, when each user uses another person's vehicle other than his or her vehicle, the occupant inevitably undergoes the inconvenience of having to re-manipulate the above systems in accordance with his or her needs. In addition, when the user's vehicle is used by another person, the user must undergo the inconvenience of having to reset his or her settings.

### SUMMARY OF THE INVENTION

Accordingly, the present invention provides a vehicle setting sharing system, which allows a driver to apply personal vehicle settings, which have been provided for his or her vehicle, to another person's vehicle as well as to the driver's vehicle, without requiring separate manual manipulation on the part of the user.

In order to accomplish the above object, the present invention provides a vehicle setting sharing system, including a storage medium configured and structured to store vehicle settings for one or more respective drivers; and a function setting unit configured and structured to receive the vehicle settings of respective drivers from the storage medium and reset functions of a function-executing vehicle based on the vehicle settings.

As described above, according to the present invention, a driver can apply vehicle settings, which have been provided for his or her vehicle, to another person's vehicle as well as to the driver's vehicle, without requiring the driver to conduct a separate manipulation of the settings in that other persons vehicle, thus improving the convenience of the driver.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a vehicle setting sharing system according to an exemplary embodiment of the present invention.

### DESCRIPTION OF THE PREFERRED EMBODIMENTS

Hereinafter, a vehicle setting sharing system according to the present invention will be described in detail with reference to the attached drawings. In the following description, detailed descriptions of related known functions or elements that may unnecessarily make the gist of the present invention obscure will be omitted. Further, the following terms are defined in consideration of functions in the present invention and for the sake of the description of the invention and may be varied depending on the intention or usage of a producer who produces the product.

The embodiments described in the present specification and the construction shown in the drawings are only preferred embodiments of the present invention and do not represent the entire technical spirit of the present invention. Therefore, it should be understood that various equivalents and modifications capable of replacing the embodiments and the construction may be present at the time when the present invention is filed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

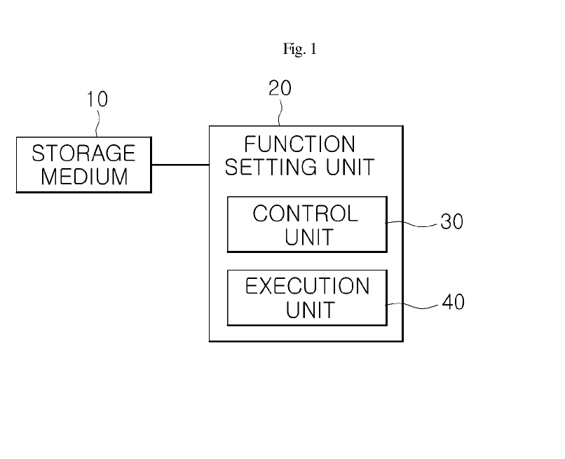

FIG. 1 is a block diagram showing the construction of a vehicle setting sharing system according to the present invention.

The vehicle setting sharing system according the illustrative embodiment of the present invention can improve the convenience of a driver by allowing the driver to apply vehicle settings, which have been provided for his or her vehicle, to another person's vehicle as well as to the driver's vehicle after another user has changed the driver's setting in his or her vehicle. The vehicle setting sharing system may include at least one storage medium 10 configured and structured to store the vehicle settings of respective drivers, and at least one function setting unit 20 configured and structured to receive the vehicle settings of respective drivers from the at least one storage medium 10 and reset the functions of a function-executing vehicle based on the vehicle settings stored thereon.

The storage medium 10 may be connected to the function setting unit 20 of a relevant vehicle via wired or wireless communication. That is, the storage medium 10 may be any one or more of a separate server for storing the vehicle settings of respective drivers, a Universal Serial Bus (USB) memory or a Secure Digital (SD) card which is a portable storage device enabling information storage, and/or a mobile terminal enabling information storage.

In this case, when a remote server is used, the server preferably stores the vehicle settings of respective drivers in various subfolders related to the vehicle. The vehicle settings may be freely adjusted by individual drivers at any time using e.g., a web server or a separate portable terminal. The vehicle settings of the driver stored in the remote server may be configured to be transmitted to the function setting unit via a wireless communication when the vehicle settings are requested by the driver in the vehicle over e.g., a telematics network Further, it should be noted that the function setting unit may also transmit the vehicle settings to the remote server over this wireless communication network as well.

When, however, the storage medium is the portable storage device, such as the USB memory or the SD card, the vehicle settings may be uploaded to the vehicle via a direct connection port located in the vehicle. Preferably the portable storage device is USB memory or the SD card. Alternatively, the vehicle settings stored in the individual mobile terminals/portable storage devices may be provided to the function setting unit 20 via Bluetooth or wired communication, thus enabling the functions of the vehicle to be set.

As described above, although several examples of the storage medium for storing the vehicle settings have been described, the storage medium of the present invention is not limited thereto, and any storage medium may be used as long as it can provide the stored vehicle settings to the function setting unit of the vehicle via the wired or wireless communication. Furthermore, the storage medium and the function setting unit may also be configured to exchange the vehicle settings therebetween.

Further, the function setting unit 20 is configured and operable to receive the vehicle settings of respective drivers from the storage medium 10 and reset the functions of a function-executing executing vehicle on the basis of the vehicle settings. The function setting unit 20 includes a control unit 30, e.g., a controller, configured to receive the vehicle settings of respective drivers from the storage medium 10, and an execution unit 40 configured to execute the function setting of the vehicle based on the vehicle settings that have been provided to the control unit 30. In this case, as described above, when the storage medium is a remote server, the control unit of the function setting unit may be configured to transmit the vehicle settings, which have been reset, to the storage medium. In this case, the control unit receives the current vehicle settings from the execution unit.

The control unit 30 transmits the vehicle settings, provided to the control unit 30, to the execution unit 40 while storing the vehicle settings. The execution unit 40 resets the functions of the function-executing vehicle based on the received vehicle settings. In this case, it should be noted that the control unit itself may reset the functions of the function-executing vehicle based on the received vehicle settings, rather than transmitting the vehicle settings to the execution unit 40. Further, the control unit 30 may preferably analyze the provided vehicle settings and transmit them to the execution unit after performing a data revision on the vehicle settings according to data relevant to that particular vehicle's settings to which the settings are to be applied.

The execution unit 40 may include a multimedia system, a Bluetooth hands-free system, and a Body Control Module (BCM). The multimedia system may include vehicle settings, such as volume, sound field adjustment (forward/backward and left/right adjustment), equalization (EQ) (low-pitched sound/medium-pitched sound/high-pitched sound), a preferred broadcasting station (preset function), and screen brightness. The Bluetooth hands-free system has settings, such as hands-free volume and a phone directory. The BCM also have various types of settings, such as the position of a driver's seat, the angle of the backrest of the driver's seat, the angle of an outside mirror, the angle of an inside mirror, the angle and height of a steering wheel, and door auto-locking setting. In this case, the execution unit may also be configured to transmit the current vehicle settings to the control unit.

The present invention having the above construction will be briefly described. When the control unit 30 of the function setting unit 20 receives the vehicle settings of a relevant driver from the storage medium 10 which stores the vehicle settings of respective drivers, the control unit 30 transmits them to the execution unit 40 via wired or wireless communication within the vehicle. Thereafter, the execution unit 40 sets the functions of the vehicle depending on the vehicle settings.

As described above, the present invention allows a driver to apply vehicle settings of his or her own vehicle automatically to another person's vehicle as well as to the driver's vehicle has his or her setting have been change by another user through automatic manipulation.

Although the preferred embodiments of the present invention have been disclosed for illustrative purposes, those skilled in the art will appreciate that various modifications are possible, without departing from the scope and spirit of the invention. Therefore, the scope of the present invention is not limited by the above embodiments, and should be defined by the accompanying claims and equivalents thereof.

What is claimed is:

1. A vehicle setting sharing system, comprising:
a storage medium configured and structure to store one or more personal vehicle settings of one or more respective drivers; and
a function setting unit configured to receive the personal vehicle settings of respective drivers from the storage medium and automatically reset functions of a function-executing vehicle based on the personal vehicle settings.

2. The vehicle setting sharing system according to claim 1, wherein the function setting unit comprises:
a control unit configured to receive the personal vehicle settings of respective drivers from the storage medium; and
an execution unit configured to execute function setting of the vehicle based on the personal vehicle settings provided from the control unit.

3. The vehicle setting sharing system according to claim 1, wherein the storage medium is connected to a function setting unit of a relevant vehicle via either a wired or wireless communication.

4. The vehicle setting sharing system according to claim 1, wherein the storage medium is a portable device configured to store information.

5. The vehicle setting sharing system according to claim 1, wherein the storage medium is a remote server connected to the function setting unit via wireless communication.

6. The vehicle setting sharing system according to claim 2, wherein the control unit converts data related to personal vehicle settings received from the storage medium to conform to an environment of a vehicle to which the vehicle settings are to be applied.

7. The vehicle setting sharing system according to claim 1, wherein the function setting unit is configured to transmit vehicle settings for a relevant vehicle to the storage medium.

8. The vehicle setting sharing system according to claim 2, wherein the control unit transmits the vehicle settings to the storage medium.

9. The vehicle setting sharing system according to claim 2, wherein the execution unit transmits the vehicle settings to the control unit.

10. A method of sharing personal vehicle settings with another vehicle, comprising:
storing, on a storage medium, one or more personal vehicle settings of one or more respective drivers;
receiving, by a function setting unit, the personal vehicle settings of respective drivers from the storage medium; and
automatically resetting functions, by the function setting unit, of a function-executing vehicle based on the personal vehicle settings.

11. The method according to claim 10, further comprising converting, by the function setting unit, data related to personal vehicle settings received from the storage medium to conform to an environment of a vehicle to which the vehicle settings are to be applied.

12. The method according to claim 10, further comprising transmitting the personal vehicle settings for a relevant vehicle to the storage medium by the function setting unit.

13. The vehicle setting sharing system according to claim 10, further comprising transmitting, by the function setting unit, the vehicle settings to the storage medium.

14. The vehicle setting sharing system according to claim 10, further comprising, transmitting, by an execution unit within the function setting unit the personal vehicle settings to a control unit within the function setting unit.

15. A non-transitory computer readable medium containing program instructions executed by a processor or controller, the computer readable medium comprising:
program instructions configured to interpret and receive the personal vehicle settings of respective drivers from a storage medium that stores one or more personal vehicle settings of one or more respective drivers; and
program instructions that automatically reset functions of a function-executing vehicle based on the personal vehicle settings.
